(19) United States
(12) Patent Application Publication
(10) Pub. No.: US 2012/0144302 A1
(43) Pub. Date: Jun. 7, 2012

(54) MEDIA PLATFORM INTEGRATION SYSTEM

(75) Inventors: Brian Campanotti, Toronto (CA); Michael Knaisch, Denver, CO (US)

(73) Assignee: FRONT PORCH DIGITAL, INC., Louisville, CO (US)

(21) Appl. No.: 13/312,566

(22) Filed: Dec. 6, 2011

Related U.S. Application Data
(60) Provisional application No. 61/419,973, filed on Dec. 6, 2010.

(51) Int. Cl. G06F 3/01

(52) U.S. Cl. 715/716

(57) ABSTRACT

A media system comprising an encoder, a storage device, a user interface, and a publishing portal. The encoder is adapted to generate one or more digital files from media comprising at least one of a video source and an audio source. The storage device is adapted to store the one or more digital files. The user interface is adapted to enable a user to select at least a portion of the one or more digital files and create metadata. The publishing portal is adapted to associate the metadata with the at least a portion of the one or more digital files, enable the delivery of the at least a portion of the one or more digital files across one or more network types to one or more device types, implement a publishing schedule for the at least a portion of the one or more digital files, and provide advertising.

### PRIORITY AND CROSS REFERENCE TO RELATED APPLICATIONS

This application is based upon, and claims priority to Provisional U.S. Application No. 61/419,973, entitled Media Platform Integration System, Method and Apparatus, filed on Dec. 6, 2010. The entirety of Provisional U.S. Application No. 61/419,973, including all exhibits and appendices are incorporated herein by reference.

### FIELD OF THE INVENTION

Aspects of the present invention relate to systems, methods and apparatus for the migration, storage, delivery, and user access of media content. In particular, but not by way of limitation, the present invention relates to one or more electronically coupled media encoding/ingesting systems, digital content storage systems, and media asset management and delivery systems.

### BACKGROUND OF THE INVENTION

In delivering media content to users, content owners often adapt to various mobile and web platforms. Additionally, content owners often direct content at individual consumers. However, embracing new content distribution mechanisms in order for proper brand dissemination and increased ad revenue to occur often results in increased human involvement, workload, time, and therefore, cost, which can lead to lower revenue.

Costs involved with adapting to changing customer distribution systems continue to increase. This “broader-casting” market is continually evolving. Broader-casting is defined as “the creation, management, buying/selling, distribution and delivery of audio, video and filmed content for global consumption on any device—stationary or mobile—including television, computer, movie screen, radio, phone, gaming console, storage, digital display and beyond.” (Source: NAB). 2009 growth in broadband alone is estimated at 31% for Latin America, 30% in Europe, 19% in the Middle East and Africa, and 15% North America. Given such changes, it is difficult for content providers to adequately distribute content across each of these areas and the systems supporting the areas. Furthermore, content consumption patterns are also continuing to change in each area, and at varying rates with evolving consumer lifestyles, entertainment options, and advances in technology. As the world continues to become more connected through the ubiquitous use of technology, content reach becomes even more important to content providers.

Content publishing and delivery is complex, as the types of content and companies offering content are varied. For example, Company A may offer types of content over distribution and delivery mediums that are different than Company B and therefore Company A may encounter different problems than Company B. For many companies, there are various barriers to adopting new media distribution networks, systems, methods, and apparatus. Although there are various mechanisms to address these barriers, most content delivery mechanism are complex and labor intensive. For example, manually-driven content capture and metadata entry systems are time consuming, which translates to a longer time-to-market. There may be limited staffing to decrease the time needed to deliver media, and the increase of cost to implement additional staff also acts as barrier to embracing advanced content distribution methods. Likewise, uncertain ROI for new manually-driven content distribution systems make additional capital investment difficult to justify. Furthermore, since new technologies are continually evolving, capital investment for custom tools can be extreme and quickly lost. Additional barriers to system upgrades often include the need to upgrade numerous content workflow components so the system may integrate into different vendor systems. Furthermore, there are legacy and proprietary metadata databases (rights management, inventory, traffic, etc.) which add to the complexity. Content stored in different media “silos” in various formats make human involvement and re-encoding necessary, further increasing costs.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

In order to continue to increase brand distribution and revenues, more efficient content distribution mechanisms have been developed which limit costs while increasing revenue. One embodiment of the invention comprises a media system. The media system comprises an encoder, a storage device, at least one user interface, and destination devices that can include a publishing portal. The encoder is adapted to generate one or more digital files from media comprising at least one of a video source and an audio source along with metadata that describes the file(s) generated. The storage device is adapted to store the one or more digital files. There is at least one user interface adapted to enable a user to select at least a portion of the one or more digital files, search and interact with the generated metadata as well as modify or create additional metadata. The publishing portal is adapted to import this metadata along with at least a portion of the one or more associated digital files transferred from the storage system, enable the delivery of the at least a portion of the one or more digital files across one or more network types and to one or more device types. The publishing portal is further adapted to implement a publishing schedule for the at least a portion of the one or more digital files. The publishing portal may also leverage the metadata delivered along with the files to automate the publishing process. Further, the publishing portal may allow the insertion of advertising material along with the original files delivered.

Another embodiment of the invention comprises a method of providing content to a device. One method comprises placing the content on a storage device and creating a content package with at least one of, the content, metadata associated with the content and establishing at least one of restore, scheduling, distribution and advertising policies for the content. The method further comprises implementing one of a first operational mode, a second operational mode and a third operational mode. The first operational mode comprises using a user interface adapted to operatively control one or more storage device features and pushing the content package to a publishing portal. The second operational mode comprises accessing a publishing portal user interface, viewing the content stored on the storage device, selecting at least a portion of the content, and pulling the content package to the publishing portal. The third operational mode comprises automated policies controlled by a “rules engine” part of one of the storage device or the publishing portal, to fully automate the restore and delivery of content packages to the publishing portal.

Yet another embodiment of the invention comprises a method of storing content files. One method of storing content files comprises monitoring a plurality of encoding folders for a digital media essence file to be created in each of the plurality of encoding folders. Each of these digital media essence files is identified by a change of at least one of its encoding format, compression scheme, raster size, pixel depth, color space, wrapper format, bitrate, frame size and progressive or interlaced format generated during the encoding process for the same media. The method may then comprise automatic transfer of each of the digital media essence files to a storage device location, each of the different storage device locations used to separate these digital media essence files in a predictable way. One method further includes implementing a storage plan for each of the storage device locations and accessing the digital media essence file via a user interface referencing an object name associated with the digital media essence file to perform the storage operation.

And yet another embodiment of the invention comprises a content archive file comprising a plurality of content essence files and at least one metadata file adapted to identify and describe the content file and may include information relating to the desired storage location for the content archive file on the storage system.

### BRIEF DESCRIPTION ON THE DRAWINGS

Various objects and advantages and a more complete understanding of the present invention are apparent and more readily appreciated by reference to the following Detailed Description and to the appended claims when taken in conjunction with the accompanying Drawings, where like or similar elements are designated with identical reference numerals throughout the several views and wherein:

FIG. 1 illustrates a block diagram depicting a media system of an exemplary embodiment of the invention;

FIG. 2 illustrates a user interface depicting a drop folder configuration of an exemplary embodiment of the invention;

FIG. 3 illustrates a user interface depicting a drop folder configuration of an exemplary embodiment of the invention;

FIG. 4 illustrates a media asset management user interface of an exemplary embodiment of the invention;

FIG. 5 illustrates a content syndication user interface of an exemplary embodiment of the invention;

FIG. 6 illustrates an analytic user interface of an exemplary embodiment of the invention;

FIG. 7 depicts a flowchart that may be carried out in connection with the embodiments described herein;

FIG. 8 depicts a flowchart that may be carried out in connection with the embodiments described herein;

FIG. 9 depicts one embodiment of a media system of an exemplary embodiment of the invention; and

FIG. 10 depicts one embodiment of a media system of an exemplary embodiment of the invention.

### DETAILED DESCRIPTION

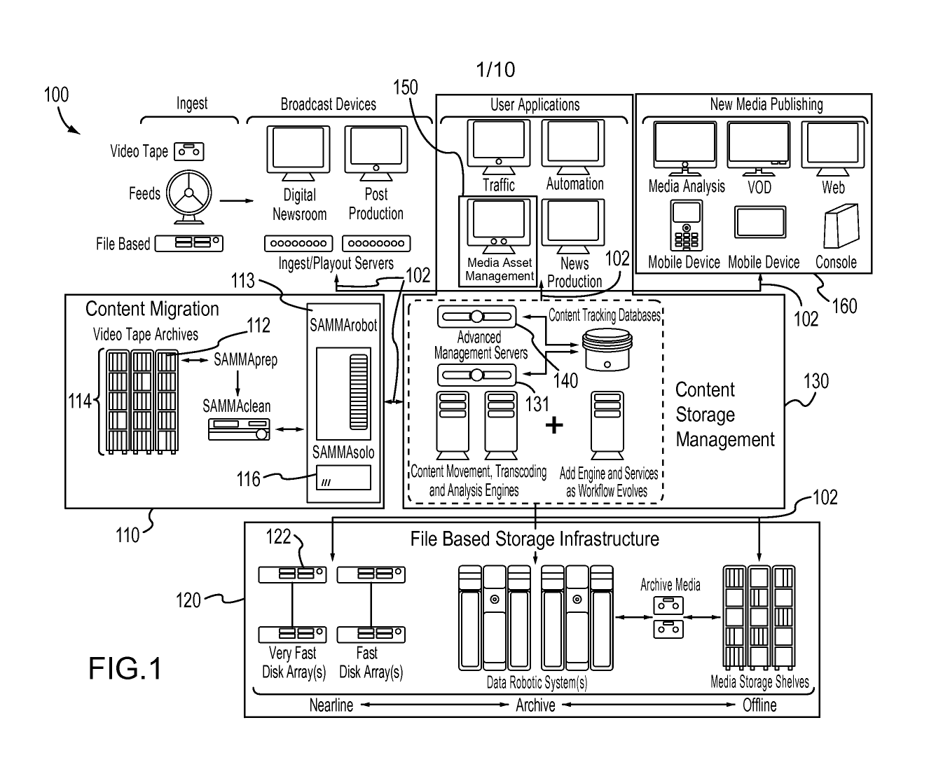

Turning first to FIG. 1, seen is a media system 100. Throughout the application, the media system 100 may also be referred to as a New Media Distribution, Online Video Platform (OVP) system or a New Media Platform (NMP) integration solution. In one embodiment an encoder 110 may migrate a content source, such as, but not limited to, video tape 112 or film stored in an archive 114 such as a video tape or film archive, to a content destination such as, but not limited to, a digital media file, which may be at least temporarily stored on one or more encoding computing devices 116. In one embodiment, the encoder may obtain media to encode from a video archive 114 comprising a portion of the storage facility 120. The content destination and/or the content source may then be transferred and stored at a content storage facility 120 comprising at least one storage device 122 such as, but not limited to, a digital storage computing device. One digital storage computing device may comprise one or more disk arrays such as, but not limited to, a very fast disk array or data tape robotic system. The storage facility 120 and/or the storage device 122 may be referred to as a storage subsystem, where appropriate.

The system 100 may further comprise a content storage management solution 130 that may include a publishing portal 140 and a media asset management (MAM) system 150, among other systems, applications, and/or devices, may provide the ability to manage the content in the system 100. The publishing portal 140 may be referred to as a new media publishing (NMP) portal or online video publishing (OVP) system. One or more portions of the content storage management system 130, the storage facility 120, the publishing portal 140 and media asset management system 150 may be local, remote, or cloud-based devices. In one embodiment, the media asset management system 150, through a user interface or otherwise (such as, but not limited to, a script or API) may select content to migrate/encode from videotape or other linear audio and/or video sources to a digital format at the encoder.

Upon encoding the content, through a series of process steps, the content storage management system 140 may transfer encoded content to the storage facility 120. Various storage types such as, but not limited to, magnetic data tape storage devices and hard drive based storage, are contemplated at the storage facility 120.

At the storage facility 120 or publishing portal 140, and in one embodiment when the content is chosen for viewing, the content may be transcoded and various analyzers and other applications may be performed on the content by the content storage management system 130. For example, the content may be repurposed, edited or reformatted prior to delivery of the content, which may occur upon a user choosing to access of the content.

It is contemplated that various aspects of the media system 100 may be accessed via one or more user interfaces that may be local or remote user interfaces such as, but not limited to, web/cloud-based user interfaces. One user interface may allow an NMP user to select pre-encoded content, whether in-whole or in-part, to be “published” (i.e., available to be viewed). In choosing content to publish, the user may leverage frame-accurate proxy versions of the encoded content. For example, proxy content may be generated at the encoder 110 during the encoding process in-parallel to encoding the content to one or more digital formats. Alternatively, the proxy content may be generated at the content storage management system 130 or publishing portal 140 as part of the transcode operation. In one embodiment, a user interface may be used to create metadata for content, enter metadata into content, and/or combine pre-configured metadata with content. In another embodiment, the encoder 110 may be used to automatically generate metadata during the migration process. In another embodiment, the content storage management system 130 may be used to process the content and automatically generate metadata.

The publishing portal 140 may perform additional transcoding or rewrapping operations that may be necessary, based on target-delivery devices 160. The publishing portal 140 may yet further enforce one or more publishing schedules by, for example, including geographical and demographical control. Advertising may also be inserted by the publishing portal 140 as set by content policies through the metadata collected during encoding 110, entered or generated by the media asset management system 150, extracted by the content storage management system 130 or entered into the publishing portal 140. The publishing portal 140 may also act as a bridge in sending content out to target devices 160 either directly or indirectly.

It is contemplated that one encoder 110 may comprise a Samma Solo Migration Platform, one content storage management system 130 may comprise a DIV Archive Content Storage Management Solution and one media asset management system 150 may comprise a DIV Adirector Media Asset Management Solution, and these or similar terms may be used interchangeably with encoder, content storage management system, and media asset management system throughout the application, respectively. For example, one Samma Solo system may comprise a high quality encoder platform which controls any standard VTR input device, accepts both analog and digital video and audio signals from the VTR and can generate multiple high and low resolution output encoded files. One Solo product may be adapted for mass video tape ingestion, and the DIV Archive system may comprise a long-term storage and repurposing solution for the ingested assets. The encoder 110 may comprise a plurality of Solo systems integrated with one or more robotic library systems to increase the speed of an automatic video tape ingest process controlled by a central Samma application. In one embodiment, a user interface may be adapted to operate with a single or any number of Samma systems connected to one or more DIV Archive systems. On-site content replication, off site content duplication, and other content storage features will be handled by the content storage management system 130 and the storage facility 120, which may have their own user interfaces, or may be accessed through the encoder 110 interface, though the operations may not be handled by the encoder 110.

It is contemplated that the media system 100 may implement at least a portion of two operational modes. A first operational mode may comprise a push operational mode where the content storage management system 130 may push content to the media publishing portal 140. The publishing portal 140 may then follow a partially or fully automated process performing any necessary transcode operations, metadata encapsulation/insertion, implementing scheduling and distribution policies, and configuring any advertising insertion in creating a content package for distribution. The publishing portal 140 may then push the package to a target device 160 and therefore to a consumer. The first operational mode may be adapted to enable a user to access the content on the content storage management system 130 through a user interface on the content storage management system 130, the media asset management system 150 or other location. A second operational mode may comprise a pull operational mode where users may be able to access the media publishing portal 140 through a user interface located at the publishing portal 140 or otherwise and see all of the encoded content stored in the storage facility 120. They are then able to select the content in its entirety or in part for publishing and then content may then pulled into the media publishing portal 140 under control of the content storage management system 130. The content may then follow a partially or fully automated process combining any necessary transcode operations, metadata encapsulation, schedule and distribution policies, ad insertion and pushes the content package to distribution and to the consumer.

Another type of operational mode may combine Samma Solo (any number of encode engines) and DIV Archive, and another operational mode may include DIV Adirector as well. In some cases, the customer may already have a Media Asset Management or other controlling system, or simply not be interested in the metadata functionality but are rather looking for long term storage. The integration of Solo and DIV Archive will have two variants described in this document. One will form a DIV Archive Object for each file generated by the Samma Solo engine, and the other will form a single DIV Archive object which will contain ALL of the formats encoded for a particular asset by the Samma Solo engine. The end customer will be able to choose their implementation method.

One benefit of implementing the encoder 110, content storage management system 130, and publishing portal 140 is that the media system 100 may be used for automatic direct targeting of any consumer platform anywhere in the world. One media system 100 can be communicatively coupled with existing and legacy systems and may be adapted to work in tandem with existing web platforms such as, but not limited to, content management systems (CMS), carrier distribution networks (CDN), advertising serving systems, analytic systems, and others.

In one embodiment, the encoder 110 may be adapted to automatically transfer content encoded by the encoder 110 to the storage facility 120, based on configured policies in the media system 100. Configured policies in one embodiment may be set through a media system 100 Drop Folder Monitor (DFM) 131, which may comprise at least one of an application and a user interface. The DFM 131 may communicatively interact with aspects of the media system—for example, the DFM 131 may be adapted to interface to the encoder 110 and content storage management system 130 for transfer of media. The DFM 131 may also be referred to as a DIV Archive Interface DFM 131 in the specification.

In one embodiment, DFM 131 may interface to the encoder 110 and the content storage management system 130 to place each digital media file generated from the encoding process into storage devices 122 in the storage facility 120—following a successful encode pass. The DFM 131 may provide a user interface adapted to enable a user to name the independent folders with any naming convention, and configure automatic handling policies and storage plans in the content storage management system 130 for automated handling.

The DFM 131 may be adapted to interface to the encoder 110 to detect the completion of each of the files generated during the migration process and subsequently control the content storage management system 130 to move each of these generated files to an appropriate location on a storage device in the storage facility 120. The DFM 131 may be configured to periodically check each of the encoder devices 116 for completed files. For example, the DFM 131 may be configured to determine a file placed in a location is complete by determining that the file size has not increase for a given time period. In one embodiment, this time period may comprise about 5 s. At this point the file may be transferred from the encoder device 116 storage to a location in the storage facility 120. It is contemplated that although there are arrows 102 in FIG. 1, the actual transfer of files to and from the varying devices in the system may take different paths than the arrows 102 display. For example, in transferring the digital media may be transferred directly from the encoder 110 to the storage facility 120, and may not be first transferred to the publishing portal 140 or the content storage management system 130. Additionally, the digital media may also be transferred through a cloud from the encoder 110 to the storage facility 120.

Once the one or more encoded files are transferred to the storage device, the DFM 131 may be configured to delete the one or more transferred files on the encoder storage. Additionally, the created digital media files may also referred to as media essence files or essence files. Therefore, by deleting the files on the encoder storage, capacity of the drive is maintained with successfully archived essence files being deleted.

When network connectivity is lost between the encoder 110 and the storage facility 120, the encoder storage may continue to accumulate content until the connection with the storage facility 120 is re-established. Upon re-establishing a network connection, the essence file transfer process will resume sending the files to the storage facility 120 and subsequently deleting the source content on the encoder 110 once the transfer is complete. In one embodiment, a “normal” state for the storage on the encoder 110 drives may comprise an empty state. The encoder 110 drives may also be referred to as the essence drives or folders or Solo drives or folders.

One naming convention for the essence files in the encoder 110 Solo drive folder may comprise filename.extension, where the filename comprises a globally unique filename in the storage facility 120 for a Category the essence file is assigned to (it is contemplated that each file may be assigned to a particular category in the storage device, depending on the nature of the essence file, as described below). Additionally, a user of the media system 100 may employ one or more asset databases adapted to store various encoded files and associated data. In one such embodiment the filename comprises a unique identifier used by the database for associating metadata with the file. The filenames for the metadata and other data associated with the file may follow a prescribed format as the filenames may flow from the encoder 110, storage facility 120, content storage management system 130 and publishing portal 140 to consumer device destinations 160. Filenames for content and associated data may be introduced at the media publishing portal 140. In other embodiments, one or more additional fields created in the content during the encoding process or otherwise for metadata placement may be used by the database and/or other application to associate metadata with the content. The terms filename, essence name and object name can each be used interchangeably, where appropriate.

The media system 100, through the media asset management system 150, content storage management system 130, publishing portal 140, or otherwise, may implement a bandwidth management feature. One bandwidth management feature in the content storage management system 130 may be used to prevent overloading of available bandwidth of the Samma system encoder 110 so the Solo engine encoder 110 can continue to process real-time encoding operations. That is, the bandwidth used by the data transfer of essence files to the storage facility 120 for archiving purposes should not limit the ability of the encoder 110 to process real-time encoding requirements received from users. Content storage management system 130 or encoder system 110 configuration parameters may be required to implement such bandwidth management. In one embodiment, the content storage management system 130 may closely monitor the available bandwidth to one or more encoding systems in the encoder 110 to ensure the encoder is not negatively affected by content transfers to the storage facility 120.

As a general note, the DFM 131 may operate with either CIFS-connected, FTP-connected, or any other protocol-connected folders on the encoders 110 or other portion of the media system 100. In one embodiment, DFM 131 operated in CIFS mode may enable a greater stability to overall operations than FTP. Any type of network connectivity and communication mechanism shall be supported between the encoder(s) 110, content storage management system 130, storage facility 120, user interface(s) such as, but not limited to the media asset management 150 UI, and media publishing portal 140 to facilitate content and metadata movement in an effective and efficient manner.

It is contemplated that there are at least two modes of DFM 131 operation that may be supported by the content storage management system 130. A first DFM 131 operation mode may comprise a single wrapped content file per object sent from the encoder 110 to the storage facility 120. A second DFM 131 operation mode may comprise a plurality of content files per object sent from the encoder 110 to the storage facility 120.

In the first DFM 131 mode, each of the encoder 110 folders adapted to receive the essence files prior to transferring the files to the content storage management system 130 may be monitored. DFM 131 may be configured to at least one of create and monitor these encoder folders and command the content storage management system 130 to create a single object for each of the arriving essence files in the storage facility 120. This allows users to leverage the content storage management system 130 under control of various application which could include MAM 150, to perform time code-based partial restore, transcoding and other media content functions on the content.

In one first DFM 131 operation mode, upon an essence file arriving in the encoder 110 cache folder, DFM 131 may be configured to form a media object in the content storage management system 130 and storage facility 120 comprising each essence file. One media object may comprise a proprietary object type adapted to be used by the content storage management system 140 and/or other portions or the media system 100. The filename given to the essence file may be assigned to the media object, and the essence filename may be assigned by a user or a script running the encoder 110 or extracted from another metadata source. The DFM 131 may then create an object with this filename in a category in the content storage management system 130. It is contemplated that in one embodiment, the encoder 110 may contain a number of folders comprising a name associated with one or more properties of the essence files (format, resolution, etc.) that will be placed in each of the folders following encoding. These folder names will be mapped to categories in the content storage management system 130 by a configuration in the DFM 131 A file extension may not be part of the object name unless desired by the customer/application, but it will often be maintained with the file contained within this created object. This ensures that when the object is restored it will be restored as filename.extension for consistency with the same original case. The content storage management system 130 may also assign storage plans to the arriving content based on the category mappings. Though under the first DFM 131 operation mode, the media object may comprise a single content file, the media object may also comprise additional file types such as, but not limited to, one or more metadata files associated with the essence files. Each of these additional file types may also comprise a filename based on the essence file filename. Each object and filename (which may be also referred to as “assets”) may be assigned a unique identifier in the content storage management system 130, where the Unique Identifier comprises a filename and category pair or other universally unique identification for the asset.

For an encoder 110 configured to provide an essence file for each encoded format, the encoder 110 may be adapted to place each encoded essence format in a unique folder. For example, the following files may be generated in the following folders:

F:\Solo\Success\Folder_Path_{—}1\ObjectName.mxf

F:\Solo\Success\Folder_Path_{—}2\ObjectName.mov

F:\Solo\Success\Folder_Path_{—}3\ObjectName.mov

F:\Solo\Success\Folder_Path_{—}4\ObjectName.wmv

F:\Solo\Success\Folder_Path_{—}5\ObjectName.mpg

The DFM 131 may be configured to monitor each of these folders periodically—for example, every 5 s, and make a determination when each of these objects stops growing in size, at which point the content storage management system 130 may archive the object in the storage facility 120. The encoder may also command one of the DFM 131 or the content storage management system 130 to provide a notification of the completion of the encoding operation rather than relying on a polling mechanism. In sending the objects to storage facility 120 via content storage management system 130, the DFM 131 may be configured to perform the following Category assignments to the files listed above:

Folder_Path_{—}1 places content in Category_One

Folder_Path_{—}2 placed content in Category_Two

. . . . Etc.

The DFM 131 may also instruct the content storage management system 130 to assign an individual storage and/or distribution plan for each folder, giving each customer configurable functionality within the content storage management system 130 and the storage facility 120. These storage and/or distribution plans may also control one or more of the subsequent transcoding, quality analysis, replication, metadata processing and publishing of the encoded assets.

Each category may be mapped to a source folder on the encoder and may be 100% independent from the folder names. However, in one media system 100 the naming conventions may be retained across platforms. Furthermore, it is contemplated that the folder names in one embodiment are related to essence/encode format. For example, the encoder 110 may place the encoded content with a filename given as “ab12345” in the following cache folders, with the folder names comprising names received from a selected format in the DFM 131:

F:\Solo\Success\JPEG2000\ab12345.mxf

F:\Solo\Success\DV25_Quarter_Resolution\ab12345.mov

F:\Solo\Success\MPEG4_{—}1000k\ab12345.mov

F:\Solo\Success\WM9_{—}500k\ab12345.wmv

F:\Solo\Success\MPEG2_{—}50I\ab12345.mpg

The DFM 131 may also be configured to transmit the objects to the content storage management system 130 and on to a storage facility 120 location having a correlation with the encoder folder names and asset categories in the content storage management system 130. For example, objects in the JPEG2000 folder may be placed in the content storage management system 130 category named J2k. Similarly, the object in the DV25_Quarter_Resolution cache folder may be placed in the content storage management system 130 category named DV25. Each of these assets may be associated with the a category having the same name in the DFM 131, content storage management system 130, storage facility 120 and publishing portal 140 and may assist in automated rules based processing of the content.

Therefore the following mappings may be created in the media system 100 by DFM 131:

| | Folder/Category Name— | |
|---|---|---|
| Object Name— | determined from essence | File(s) Contained |
| established by user | file attribute | in Object |
| AB12345 | J2K | ab12345.mxf |
| AB12345 | DV25 | ab12345.mov |
| AB12345 | MPEG4 | ab12345.mov |
| AB12345 | PROXY | ab12345.wmv |
| AB12345 | MPEG2 | ab12345.mpg |

Each of these monitored folders can also have a separate storage plan associated with it through DFM 131 and controlled by the content storage management system 130, dictating transcoding requirements, metadata mining, quality assurance processing, number of copies made on data tape, cloud storage, offsite replication via other applications and devices such as, but not limited to DIV Anet, etc. These storage plans may be fully configurable on a customer-by-customer and folder-by-folder basis and modified over time as necessary.

Upon placement of the files in the storage facility 120 and assignment of the categories in the content storage management system 130, each of the objects and files, which may also be referred to as “migrated assets”, “assets”, “objects” or “media assets”,may be accessed by, but not limited to, interfaces such as the MAM system 150, end users of the publishing portal, etc. by referencing the unique object name and/or category name assigned to the asset in the content storage management system 130.

In one first DFM 131 operation mode, the encoder may generate metadata files (which may be in XML format) associated with the media assets during encoding. The metadata files may be placed in a metadata folder on the same encoder as the asset, so the folder set listed above may also include:

F:\Solo\Success\XML\ab12345.xml

These metadata files may be archived to the content storage management system 130 in a process similar to the essence files listed above. A specific storage plan may be assigned to the XML directory, as described previously. When metadata files are stored at the storage facility 120, the following list of objects may be formed as per the example above:

| | | File(s) Contained |
|---|---|---|
| Object Name | Category Name | in Object |
| AB12345 | J2K | ab12345.mxf |
| AB12345 | DV25 | ab12345.mov |
| AB12345 | MPEG4 | ab12345.mov |
| AB12345 | PROXY | ab12345.wmv |
| AB12345 | MPEG2 | ab12345.mpg |
| AB12345 | XML | ab12345.xml |

The metadata file may be referred to as encoder, essence and/or migration metadata and it may be copied, preserved and restored as if it were simply another essence file in the storage facility 120.

The second DFM 131 operation mode comprises a Multiple Files Per Object Mode or Composite Object Mode. In one second DFM 131 operation mode, the DFM 131 may monitor a single folder awaiting the arrival of a properly formatted DFM instruction or script file which lists (i) each of the files captured by the encoder 110 during the encode operation, (ii) their path, and (iii) the desired filename and/or Category for the essence files. In this operation mode, the encoder may also signal DFM 131 or the content storage management system 130 directly rather than generating this instruction or script file to notify of the completion of the encode operation and list (i) each of the files captured by the encoder 110 during the encode operation, (ii) their path, and (iii) the desired filename and/or Category for the essence files.

The objects in the second DFM 131 operation mode may comprise objects which contain more than one essence file/format. This composite object is treated as a single asset in the content storage management system 130 and the storage facility 120, but user interfaces can access one or more of the essence files contained in this composite object as necessary. Similar to the first DFM 131 operation mode, these new objects will be assigned an object name and a category. However, the category may not be related to a particular format or essence file feature since it may contain more than a single essence file. Instead, the category may be related to content ownership, etc.

The second DFM 131 operation mode may be fully compatible with the path structure proposed above as the instruction file would include a reference pointer to the essence files in each of their independent folders. The metadata file generated during the encode may also be included along with the essence files to comprise the composite asset. These files may be kept together as a single package in the storage facility 120 under control of the content storage management system 130. Whether to use the path structure under the first DFM 131 operation or to keep the files together in a single directory may be a configuration choice for the user. Additionally, the configuration may be adapted to set which essence files should be included in the composite object.

The second DFM 131 operation mode may monitor a single directory awaiting the arrival of a DFM 131 instruction file or a notification from the encode system 110 which would signify the end of the successful encoding process. All of the essence files may be fully copied to a folder before the instruction file is generated or notification is signaled. The file and path configuration on the encoder 110 may be something like:

F:\Solo\Success\JPEG2000\ab12345.mxf

F:\Solo\Success\DV25_Quarter_Resolution\ab12345.mov

F:\Solo\Success\MPEG4_{—}1000k\ab12345.mov

F:\Solo\Success\WM9_{—}500k\ab12345.wmv

F:\Solo\Success\MPEG2_{—}50I\ab12345.mpg

F:\Solo\Success\XML\ab12345.xml

The DFM 131 may be configured to form a single object for each set of encoded files which result from a successful encoder 110 ingest process. For example, a single object may be created for the above set of files. The DFM 131 instruction file may specify a filename to use as the object name, which may match the filenames of the included essence files. For example, for the above essence files, the ab12345 may be used as the object filename. However, alternative filenames may be used as well that are different than the names of the files contained in the composite object. The category can also be included in the DFM 131 instruction file. The category may be set by the user during encoding or a default Category may be assigned for the created essence files. For example, a field may be included in an encoder 110 user interface, allowing the encoder 110 operator to assign a Category to the content currently being ingested. Alternatively, or in addition, the DFM 131 may be configured to set a default Category which may only be changed, for example, by a system administrator, if desired.

Using the example essence file list above, in this second DFM 131 operation mode the content storage management system 130 may form a single object containing all of the essence files and the Solo generated XML file if referenced in the DFM 131 XML file:

| DIVArchive | DIVArchive | File(s) Contained |
|---|---|---|
| Object Name | Category Name | in Object |
| AB12345 | DEFAULT | XML\ab12345.xmlJPEG2000\ab12345.mxf |
| (or other name | (DFM 131 default | DV25_{—}Quarter_{—}Resolution\ab12345.mov |
| specified in the | category or category | MPEG4_{—}1000k\ab12345.mov |
| DFMinstructionfile) | specified in the DFM | WM9_{—}500k\ab12345.wmv |
| | instructionfile) | MPEG2_{—}50I\ab12345.mpg |

It is possible for the content storage management system 130 to store these files in the storage facility 120 with or without the unique portion of the source path, which is first portion of the filename preceding the given filename (ab12345), and indicated in BOLD in the above table. For example, the unique portion of the source path may be removed if the DFM 131 determines and verifies that the given filename portion is unique. If no verification is performed and the unique portion of the source path is not retained, it may be difficult to differentiate between content filenames when restoring or partially restoring the essence files the multiple restored files may have similar names. The DFM 131 can be configured to establish a unique name and a unique category for each essence file and/or object created.

If the metadata file is included in the composite object package, it may appear first in the list of files in the DFM 131 instruction file to allow the content storage management system 130 to determine whether this is a package generated by the encoder 110 or some other object not generated by the encoder 110. Again, the requirement for uniqueness in a single category exists: Category+ObjectName=Unique Identifier for the object “asset” in the storage facility 120 and publishing portal 140.

Similar to the mode of operation described in the previous section, a specific storage plan within the DFM 131 can be assigned to the composite asset, specifying items such as, but not limited to, multiple data tape copies, offsite replication, etc. However, there may be limitations in the use of some media archive features such as timecode-based partial restore, transcoding and various analyzing functions which may be provided to the user under the first mode of operation.

These composite objects may be accessed through media system 100 user interfaces such as, but not limited to, a media asset management 150 interface, the content storage management system 130 or a storage facility 120 interface by referencing the object name assigned to the whole asset/composite object and the category containing the complete object package. Partial restore operations can be used via the MAM system 150 or via a publishing portal 140 or content storage management system 130 API to extract one or many of the essence/metadata files contained within these composite objects. In addition to providing the user an option to store the metadata file, which may include important essence and asset metadata, it may also be possible to have some of the information in this file passed to the media asset management system 150 or other media system 100 portion, as desired to assist in human interactions with the assets.

In one embodiment, communication between one or more of the encoder 110, media asset management system 150, publishing portal 140, content storage management system 130, and storage facility 120 may occur via an API rather than, or in addition to, relying on the DFM 131. For example, the API may be used to provide the same functionality described in the preceding sections of this document as the DFM 131 with the two modes of operation.

In one embodiment, when content is generated by the encoder 110, in setting the filename for the essence files and the object, the encoder 110 verifies that duplicate filenames in each category are prevented. For example, the encoder 110 may compare all filenames currently in the category to the current filename to ensure each file name is different. However, it is still possible that a filename may be duplicated in a particular category—for example, if multiple, separate encoders 110 are placing content to a single category in a storage facility 120 through a single or different publishing portals 130. If content is received from the encoder 110 with a duplicate ID (filename+category) as a current content file or object, the DFM 131 may be configured to delete the previously archived content with the same ObjectName+Category combination as the newly arriving item and re-archive this new content, in essence deprecating the older content. Alternatively, the DFM 131 may be adapted to save either the previous or the new file/object as a different filename. Furthermore, DFM 131 may comprise a feature to replace existing files and/or objects. For example, when video tapes are re-ingested because of issues noted during the initial ingest operation, the original essence file(s) and/or object may be replaced. This and other similar modes of operation may be configurable in DFM 131.

One embodiment of the media system 100 supports timecode-based partial restore for many formats of audio/video content, allowing selected portions of the encoded content to be published via the NMP to various platforms and destinations 160. Furthermore, the media system 100 and publishing portal 140 may be adapted to support in-path transcoding of various formats of audio/video content en route to the destinations 160 to ensure compatibility within a content owner's facility as well as compatibility with the NMP platforms and destinations 160 which the content will be delivered to. As content is drawn from the storage facility 120 (following either the PUSH or a PULL model described above), the publishing portal 140 may determine what, if any, transcode operations are necessary for the particular destination 160, including one or more NMP destinations 160, and perform any necessary format transcoding operations as part of a chosen content restore operation. Format transcoding can take place within the publishing portal 140 or in the cloud by the NMP preparing content for delivery to the different viewer platforms.

In one embodiment, the Media Asset Management (MAM) system 150 may be interfaced to the content storage management system 130 and storage facility 120 via an API. Through the API, or otherwise, the media asset management system 150 may be adapted to access a proxy browsing function, leveraging a low-resolution proxy file generated by the encoder 110 during the ingest process along with metadata captured or generated by the system. These low-resolution proxy files may be placed in a proxy drop folder (PDF) for the MAM system such as, but not limited to, DIV Adirector, to access and register within the MAM system. The proxy files may also be archived to the storage facility 120 under control of the content storage management system 130. Therefore, the encoder 110 may be adapted to create two copies of the proxy file. A first proxy file may be passed to the MAM system to enable the user to browse the proxy files. A second proxy file may be included in the storage facility 120. It is also contemplated that a single proxy file may be created, with the MAM system accessing the storage facility 120 proxy file to enable browsing. In one embodiment, the encoder 110 may generate two or more versions of the proxy file, such as, but not limited to, proxy files comprising different bitrates, with one of the files being send to the MAM system and the other to be archived at the storage facility 120 along with the other essence formats.

In one embodiment, the MAM system may comprise the PDF, while in other embodiments the PDF may reside on the storage facility 120 or other media system 100 portion. A PDF user interface may enable an administrator to define a Category to use as a default category on a per-PDF basis. The user interface may also allow encoder 110 users control over how the proxy files get associated with storage facility 120 objects at the MAM system. The user interface may also enable the administrator to configure each of the proxy drop folders to allow them to configure a single “category” each proxy should be associated with. In one embodiment, a proxy file dropped in a drop folder with name such as, but not limited to, filename.wmv, may be matched with a first object found in the database with a matching filename, regardless of its category. Alternatively, the proxy drop folder may specify which category the proxy file should be associated with, and therefore, which category the proxy file should be saved within the content storage management system 130. By default, a category setting may comprise a blank setting, which may cause the proxy file to match with a first object found in an associated database such as, but not limited to, a MAM system database. The category setting filed in a MAM system user interface or otherwise may be a text entry box which may allow an administrator to manually entry the name of a Category to match the dropped proxy with. The setting may be case insensitive and the entered category name may be required to match exactly the specific category name in the content storage management system 130, publishing portal 140 and/or storage facility 120. Several drop folders may also be used, each with different matching categories so a single proxy file may be associated with multiple categories/formats.

In one user interface, such as, but not limited to, a web interface adapted to access one or more portions of the media system 100 may provide one or more dialog boxes adapted to enable a proxy file naming convention and a category specification on a folder by folder and proxy file by configuration. An administrator or other user may be able to enter specific Category names in a category field. For example, setting a “Proxy filename Format” menu option to an “Object name only” choice will enable the ability to establish a specific category name for each proxy file. If the “Proxy filename Format” menu is set to, for example, an“Object Name+Category” choice, then the category field may be disabled as the proxy filename may include the category received from the encoder 110, user, or other location, and such a setting may override any desired category name.

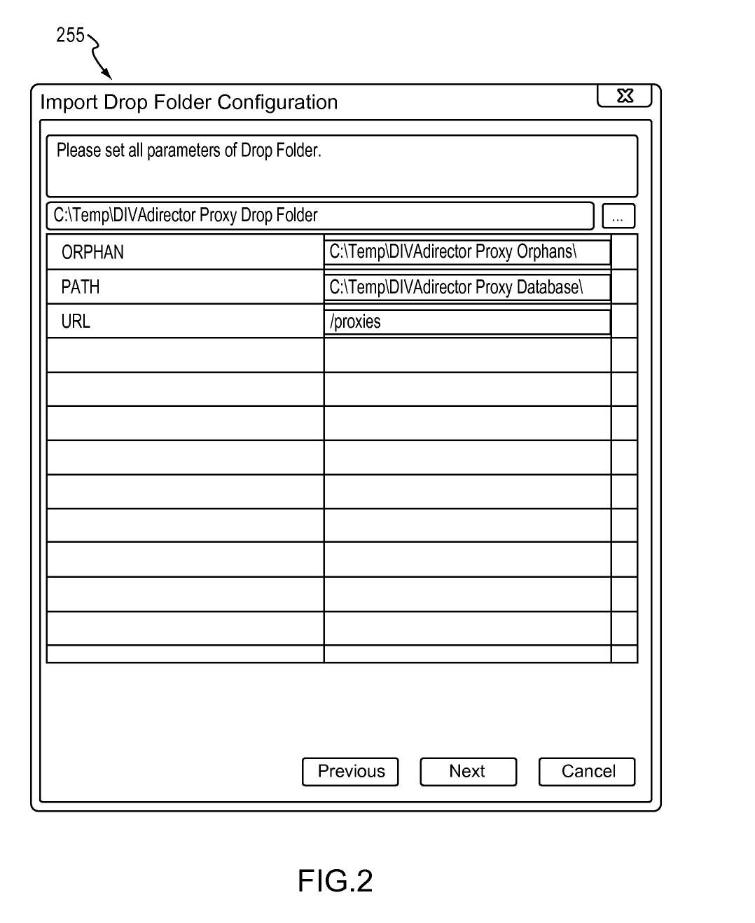

Seen in FIG. 2 is one example of a proxy drop folder configuration user interface 255. Such a proxy drop folder configuration user interface 255 may enable the association of a proxy file with a specific category of content within the storage facility 120. For example, in the single-file-per-object mode of operation, proxy drop folder configuration user interface 255 may enable the customer to associate one or more proxy files with the JPEG2000 content instead of the 50I content, if desired. In the composite-object mode of operation, this feature may enable setting a proxy file category to the category of a first content storage management system 130 object found. Alternatively, a category may be specified in this instance as well. Upon receiving a proxy file from the encoder 110 or other media system 100 portion at the MAM system, the proxy file may be validated by the within the MAM system to ensure full compliancy with MAM system formats and system requirements.

In some cases, the customer may desire that a single proxy be associated with a category name of all objects comprising a matching filename. For example, an administrator or other user may be able to enter a character such as, but not limited to, a special asterisk string (*) into a category name dialog box. Such a character may cause each proxy file having such a character in the “category” dialog box to be associated with all objects having a matching filename in all content storage management system 130 and/or storage facility 120 categories. In one embodiment, the media system 100 does not make additional copies of the proxy for each category. The media system 100 may reference the same proxy file in all matching objects in the system. For example, if, for a proxy filename AB1234, the same filename is found in the categories MXF, DV25 and HD, then a single proxy dropped into a proxy drop folder with “All” in the category matching field would cause this single proxy to show a proxy play icon beside each of the MXF, DV25, and HD object icons displayed in a MAM system. One media system 100 may be configure to remove a proxy file (if configured to do so) only after a last matching object has been deleted from the system. It is also contemplated that the MAM system may assign a plurality of categories to a single PDF.

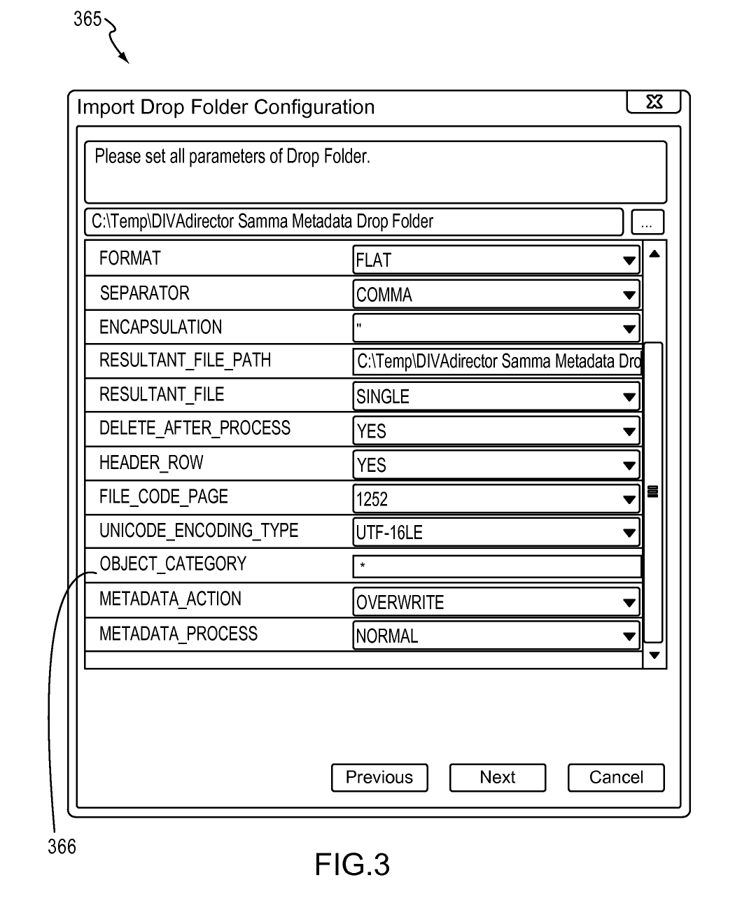

In one embodiment, one category may be assigned per drop folder. The assigned category which may be forced by the system to match a category assigned to metadata deposited in the folder. The system may further ensure that there is a field in the metadata file listing a category that matches the assigned category. In the case of the Solo metadata file (i.e., the single content file per media object), metadata may be matched with all matching objects irrespective of their category because the metadata is applicable across essence formats for the same source content. Similar to the feature described for proxy handling, a metadata configuration user interface 365 may comprise a drop folder adapted to allow the entry of a character such as, but not limited to, a special asterisk string (*) in a Category definition field 366, as seen in FIG. 3.

Assigning the special asterisk string may cause the parsing and updating of each metadata file for all objects comprising matching filenames irrespective of their category. Each metadata file may be updated with the information in each metadata file dropped in the assigned folder. For example, if there are two categories within the content storage management system 130 and the storage facility 120 comprising categories DV25 and H264, with each category containing an object named AB1234, then a metadata drop folder configured with this * character will allow a metadata file comprising the filename AB1234 and some metadata to update the appropriate file of both the DV25 and H264 assets. For example, a metadata file may be assigned in the MAM 150, content storage management system 130 and/or publishing portal 140 to be updated with metadata information.

One media asset management system 150 may not comprise special metadata handling functionality. Such a system 150 may receive metadata from customer databases leveraging a metadata import mechanism. One metadata import mechanism may comprise comma-delimited file functionality. Another metadata import mechanism may comprise direct programmatic integration with the system. In one embodiment, the metadata may be assigned to the assigned content through the system without assigning metadata filenames and categories. However, in some cases, it may be desirable to parse the received metadata into separate fields. For example, an metadata file such as, but not limited to, a Solo XML file, created during the encode process may comprise one or more user or system-defined metadata fields. Through an XML file (or other file type) these fields may be passed to the MAM system. In one embodiment these files may be passed to the MAM system in a comma delimited format via a metadata drop folder mechanism. For example, once the encoder 110 ingest process is complete and the XML metadata file is created, a process/application may be implemented which extracts the relevant metadata fields from the file and creates a metadata CSV file. The metadata CSV file may only contain the fields and may comprise a filename comprising filename.txt or filename.csv. This file may then be deposited in a MAM system metadata drop folder at any point following the ingest process. The metadata drop folder may be configured to review the file for the field mappings. The metadata may then be associated with all matching content the MAM system comprising the same filename in the case of single file per object mode of operations.

In one embodiment, the MAM system may be adapted to support a special metadata drop folder. This may enable an XML file such as, but not limited to, the Solo XML metadata file to be deposited in the drop folder. Upon placing the metadata file in the drop folder, the metadata file may be accessed and stored in a MAM system binary storage location. A reference to the file may also be placed in a binary metadata field in the MAM system. The metadata drop folder may comprise a plurality of drop folders which may be configured to (i) provide for any category or a specific category, (ii) determine when and how to process files arriving in the drop folder, (iii) provide which binary metadata field the arriving file should be placed in, (iv) establish an orphan location, (v) provide for a cleanup interval, and (vi) any other relevant parameters.

In some cases, the customer may choose to have the metadata file stored with the object (composite or single file per object) within the content storage management system 130 and storage facility 120. In such a case, the encode engine must be able to create two copies of the metadata file, one to pass to the DIV Adirector drop folder and the other to be included along with the DIV Archive object.

The binary metadata functionality described above may enable the metadata to be preserved and accessed along with the proxy file and other relevant metadata within the media asset management system 150. This may enable the information to be accessed, for example, from a web browser without having to access additional information from the content storage management system 130, the publishing portal 140 and/or the storage facility 120. The metadata may be associated with all objects comprising matching filenames the media asset management system 150 for a single file per object mode of operations.

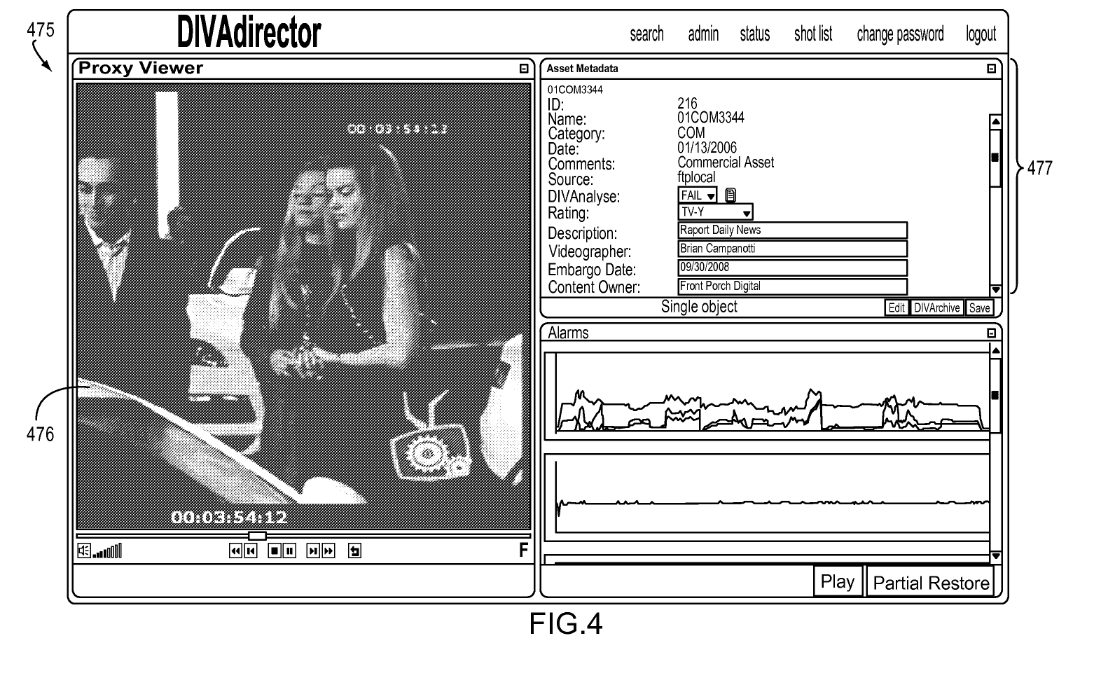

In one embodiment, the media asset management system 150 may provide the ability to click on an metadata file such as, but not limited to, clicking on the Solo XML file received from the encoder 110 through a user interface link to the appropriate binary metadata field. The user interface may forward a user to a new page in the interface to display data associated with the metadata fields. For example, one or more graphs and/or charts may be displayed upon accessing reference data in a database. Additional functionality may be provided to the user such as, but not limited to, allowing advanced zoom control, etc. on the content. In one embodiment, the media assent management 150 system may comprise the media asset management user interface 475 seen in FIG. 4. The user interface 475 may comprise a proxy viewing portion 476 enabling a user to move through the metadata 477 and view the proxy content as they do.

In one embodiment, the encoder 110 may provide one or more summary metadata elements. Such elements may accumulate, or “roll up”, the large amount of collected metadata during the encode session. The encoder 110 may parse the captured metadata for each of the encoded files and may generate one or more summary fields in realtime during the encode operation. Summary fields may include one or more of (i) Source Quality—Summary calculation producing a value between 0-100 quantifying the overall quality, (ii) Start Timecode—Start timecode for the encoded content (HH:MM:SS:FF), (iii) Duration—Duration for the encoded content (HH:MM:SS:FF), (iv) End Timecode—End timecode for the encoded content (HH:MM:SS:FF), (v) Frame Rate—Frame rate for the original content, (vi) Average Luma—Average luminance value for the item, (vii) Average Chroma—Average luminance value for the item, and (viii) Average Audio Level. In one embodiment, the Source Quality may comprise a weighted combination of parameters from the video tape captured during the encoding process which will provide an overall quality measure of the content. All of these fields may be included in a summary metadata section of an xml file such as, but not limited to, a Solo XML file, and the fields may be parsed and included in the media asset management 150 metadata file for representation in the web/user interface.

In one embodiment, a user may use the media system 100 to access encoded content. It may be desired to only view or obtain a portion of an encoded asset. In such a case, a partial restore of the content file may provide the desired content portion. In the case of a composite object in the media system 100, a single file may be restored in its entirety from the composite object. In one embodiment, the media asset management system 150 may be used to restore a single or multiple files from a composite object. In one embodiment, a configuration setting may dictate whether the system should provide a single file per object mode of operations or composite object mode of operations. The single file per object mode of operations may be a default.

In a composite mode of operation, the MAM system may allow the user to select a Partial Restore operation which may enable the user to define a starting and ending point of the partial restore and/or may allow the user to select from a list of files contained within the object for restoration. The user may enable a shot list feature which may define a list of desired shots for the selected content. In one embodiment, checkboxes in a partial restore portion of a user interface may allow the user to select one or more of the files contained within the composite object. This list of files may be provided from the MAM system or publishing portal 140 to the content storage management system 130 accessing the composite object at the storage facility 120 and determining the file list.

In one embodiment, the encoder 110 may determine a checksum for each generated content file and/or object. The content storage management system 130 may take these checksum values calculated as the content is being generated and use them to “certify” the content as it is being archived. For each essence file, the encoder 110 may generate an metadata file containing the checksum values calculated for the content which will be read by the content storage management system 130 prior to transferring the encoded content to the storage facility 120 or the destinations 160. Following the transfer, a real-time checksum value, which may be calculated by the content storage management system 130 during the transfer, may be compared to the checksum value generated by the encoder 110. If the values match, the process may continue. This provides full end-to-end certification of the content being generated by the encoder 110.

In one embodiment, the encoder 110 should be able to generate a virtual shot list for content being encoded by detecting periods of black/silence and/or periods of barcode demarking clips on the original video tape. The encoder 110 may auto-segment the original content—producing independent files for each of these detected “clips”. Alternatively, or in addition to the auto-segment functionality, the encoder 110 may also generate a shot list file identifying the start timecode and end timecode for each of these clips. A metadata file comprising at least a portion of this data may be passed to the media asset management system 150. The MAM system may import the clips as proxy files for the original essence file. A user may then use the clips for proxy browsing. Upon selecting a clip, the user may access and restore at least a portion of the larger, raw essence file. In one embodiment, the proxy clips and the larger essence file may comprise a parent/child relationship within the media asset management system 150. Additionally, or alternatively, the shot list functionality may be employed. In one embodiment, metadata may be created for each of these virtual proxy file content segments in addition to the metadata for the parent essence-file asset. The media asset management system 150 may use the proxy metadata to view the proxy segments, perform partial restore operations of the essence file, modify the content, delete content files—proxy or otherwise, etc. The media asset management system 150 may also be adapted to assign a category for each proxy drop folder. This may ensure the proxy gets attached to the correct object in the single object per format mode. It may also be possible to associate the same proxy with multiple categories.

In one embodiment, the media asset management system 150 may comprise binary file drop folders. Each folder may be assigned to a Category and a binary metadata field. Files dropped into the folder may follow the filename.extension format, causing the file to be copied to a binary storage path, with a reference added to the correct metadata field. This function may be used to preserve an xml file delivered to the MAM system. In a multiple file per object mode, the encoder 110 may deliver to the MAM System via the DFM 131 a properly formatted instruction file with all of the necessary file pointers, etc. The MAM System may enable browsing of the encoded content and the media system 100 may also archive the composite asset.

In one embodiment comprising control of the content storage management system 130 through one or more API, a “transfer manager” module may be included which manages the communication between the encoder 110 and the content storage management system 130.

In order to prevent issues arising from encoded content comprising the exact same name, a portion of the source path may be included with the filename in each of the files contained in the composite object. Additionally, the media asset management system 150 may comprise a XML to CSV converter to parse the high level metadata fields and generate a comma delimited file, which may be placed into the MAM System metadata import folder. The comma delimited file may include only basic metadata information passed to the MAM System in the Solo XML file, and may be placed into the MAM System folder with a .csv or .txt extension.

The delivery of files from the encoder 110 to the storage facility 120 via the content storage management system 130 may be asynchronous and therefore the system may not comprise any time of arrival dependencies for content or metadata. It is further contemplated that the XML files may be viewed directly from a web browser. Additionally, as the encoder 110 delivers many different high-resolution encode formats, the content storage management system 130 may validate the ability to transcode and at least partially restore each of these formats.

DFM 131 may include a strategy for files with names which already exist within the storage facility 120 to either delete or rename the previous and then replace them with these newly arriving essence files. This may be necessary when video tapes are re-ingested because of issues noted during the initial ingest operation. This mode of operation may be configurable in the DFM 131.

Content may be distributed to one or more end user destinations 160 through a service. Content stored in the storage facility 120 may be “published” to any of the supported platforms (e.g. TIVO, Roku, iTunes, Web, syndication, etc) via the content storage management system 130 and the publishing portal 140. Content is automatically transcoded, quality checked and paired with relevant metadata en route to distribution by the publishing portal 140. Through such distribution of content, costs typically associated with implementation of new services and day-to-day operational staffing may be reduced. There may also be a reduction of workflow duplication and an increased content reach to the consumer via automatic distribution to any platform. Increased revenue may accrue from internally served ads as well as through direct integration to ad services.

Features of one publishing portal 140 may comprise Dynamic Content Distribution including Dynamic file generation for multiple codecs and platforms, and Integration with one or more CDNs. An additional feature may also comprise Syndication including Support for multiple affiliates and distribution portals. Multiple Viewer Platforms including Web, iPod, Zune, iPhone, Android, Apple TV, Tivo, Vudu, Roku, etc, are also considered. Additionally, Monetization comprising integration with multiple ad networks and ad servers is one additional feature. Finally, another feature may comprise Analytics including Integration with InPlay, Visible Measures and Omniture, and Internal data marts for downloadable media.

One encoder 110 is adapted to efficiently migrate legacy video tape content and supports all legacy video tape formats with a focus on reduced human involvement through software-driven robotics adapted to migrate hundreds of hours per week per system. The encoder 110 system may generate preservation-quality digital files in addition to formats for direct new media publishing via the publishing portal 140.

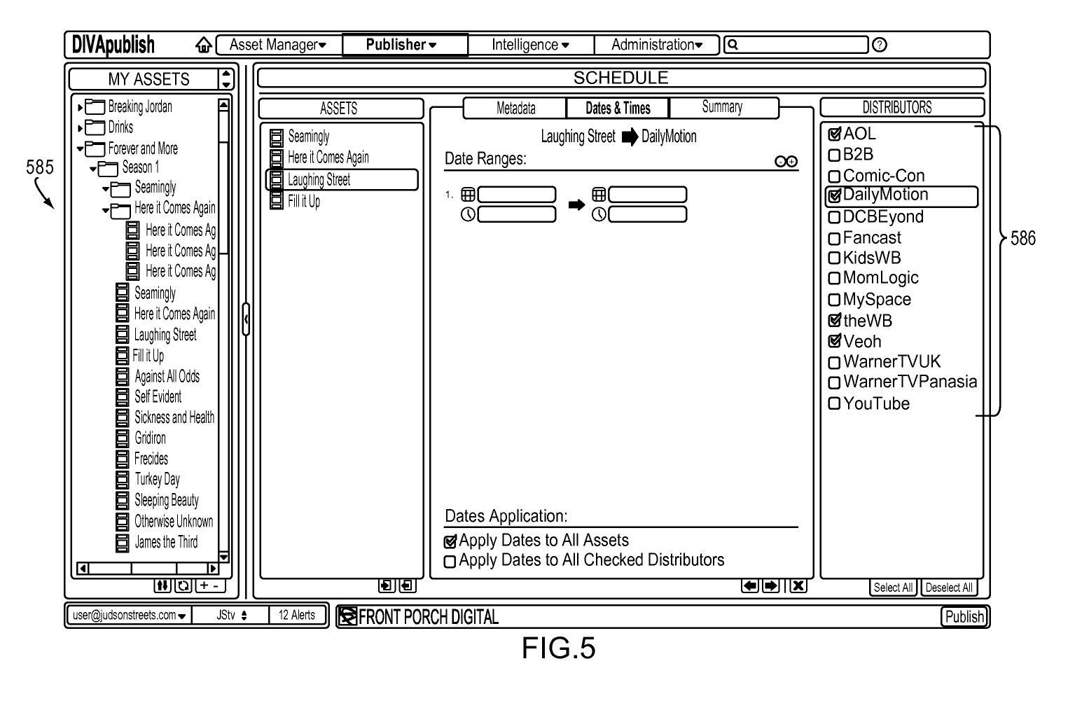

Seen in FIG. 5 is one example of a content syndication user interface 585. Content syndication may occur through template-based business rules with varied messaging or content for each device. A plurality of checkboxes 586 may enable the scheduling of content distribution to the target/syndication platforms. Automatically generated metadata may guide the content through the remainder of the process. Content syndication may comprise server-side automation.

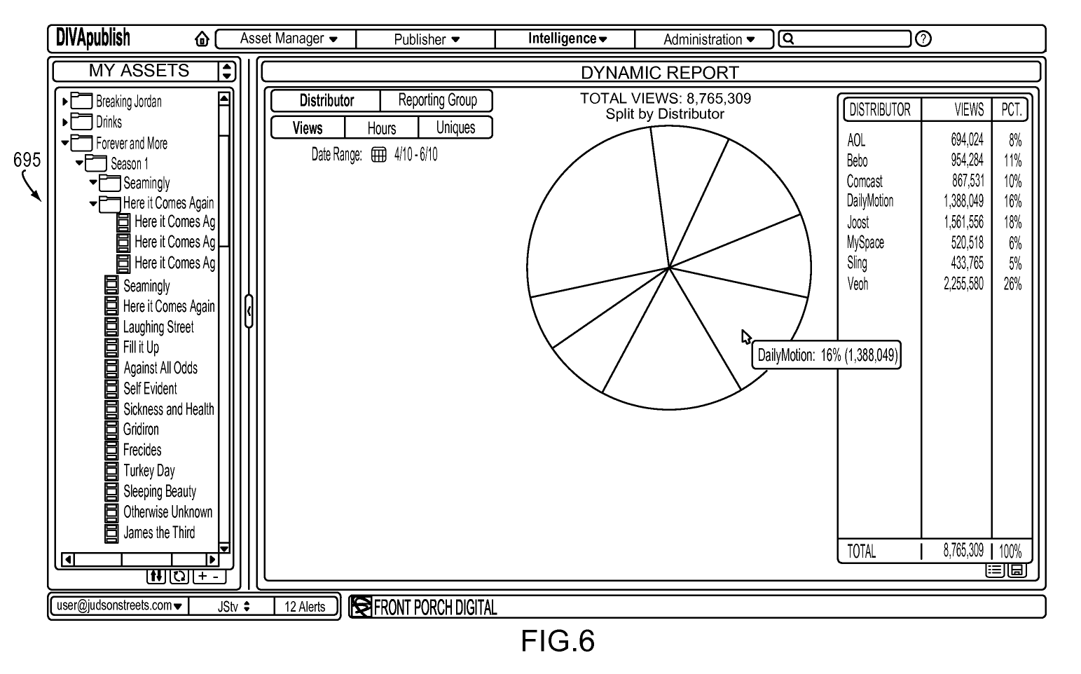

Seen in FIG. 6 is one example of an analytic interface 695. Types of analytics provided may comprise (i) engagement metrics, (ii) Audience Insight: geo, search terms, per show revision, (iii) Syndication: viral spread and affiliates, (iv) Export in multiple formats (csv, xml, xls), and (v) Integrated views of portals, affiliates and destination sites.

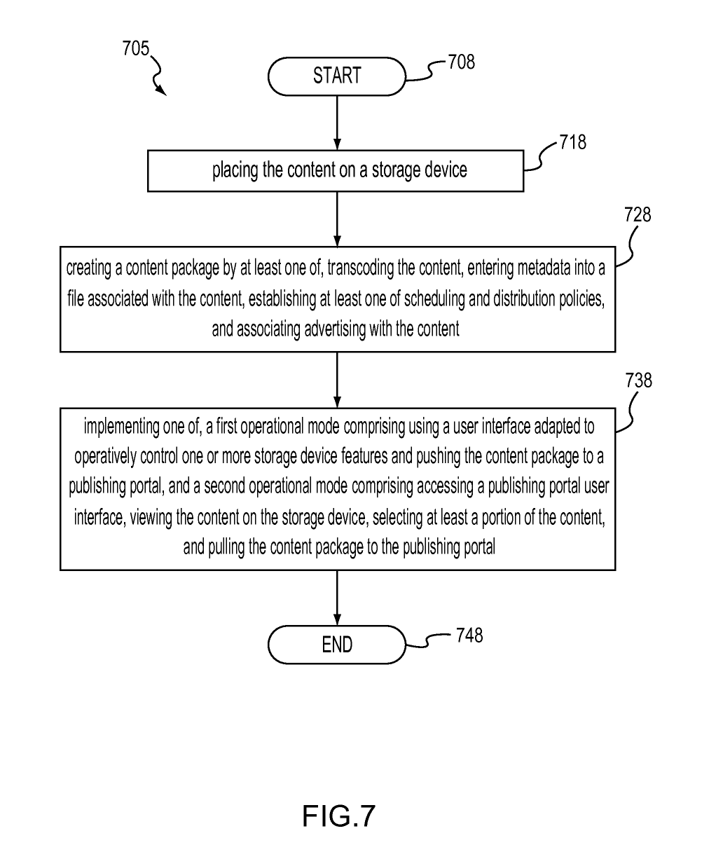

Turning now to FIG. 7, seen is a method 705 of providing content to a device. One device may comprise one of more of the destinations 160 seen in FIG. 1. The method 705 starts at 708 and at 718 comprises placing the content on a storage device. In one method 705, placing content on a storage device may comprise placing encoded content from the encoder 110 on the storage device 122, as seen in FIG. 1. At 728, the method 705 may further comprise creating a content package by at least one of, transcoding the content, entering metadata into a file associated with the content, establishing at least one of scheduling and distribution policies, and associating advertising with the content. For example, upon a user at a destination 160 choosing to view at least a portion of a stored content file, the content file may be transcoded so the content may work with the end-user device. Metadata associated with the content may be packaged with the transcoded content by the publishing portal 140 in the process of operatively sending the content as a content package to the destination 160. At 738 the method may comprise implementing either a first operational mode or a second operational mode. For example, the first operational mode may comprise the publishing portal 140 providing a user interface to access the desired content and upon content selection and packaging, pushing the content package to the publishing portal 140 and/or destination 160. The second operational mode may comprise accessing a publishing portal 140 user interface, viewing the content on the storage device, selecting at least a portion of the content, and pulling the content package to the publishing portal 140 and/or destination 160. The method 705 ends at 748.

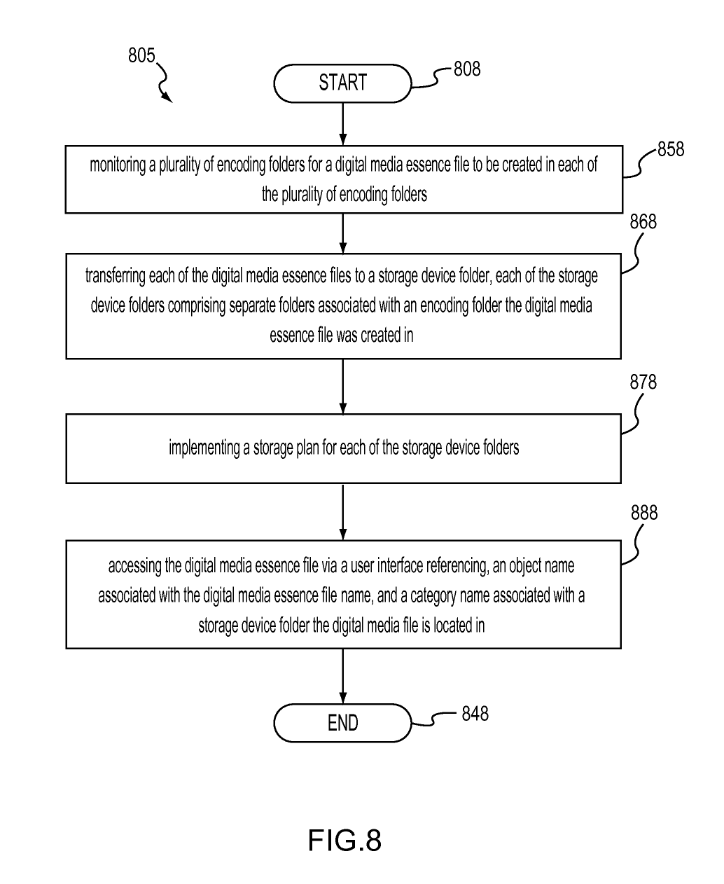

Turning now to FIG. 8, seen is a method of storing content files. The method 805 starts at 808 and at 858 comprises monitoring a plurality of encoding folders for a digital media essence file to be created in each of the plurality of encoding folders. For example, a folder at the encoder 110 may be monitored. At 868 the method 805 comprises transferring each of the digital media essence files to a storage device folder. This may comprise transferring the essence file to a location in the storage facility 120. Each of the storage device folders may comprise a separate folder that may be associated with the encoding folder that the digital media essence file was created in. At 878 the method 805 comprises implementing a storage plan for each of the storage device folders. At 888 the method 805 comprises accessing the digital media essence file via a user interface referencing an object name associated with the digital media essence file name and a category name associated with a storage device folder the digital media file is located in. The method 805 ends at 848.

It is further contemplated that one embodiment of the invention may be adapted to enable content and metadata to be automatically delivered to a device destination 160 upon the content being encoded, and the metadata being collected, at the encoder 110. For example, a video source such as, but not limited a videotape may be loaded into an encoding device such as, but not limited to, a robot device 113. The media system 100 may comprise a “rules engine” which may comprise an application adapted to create and collect metadata and automatically deliver the metadata and digital content encoded by the encoder 110 to a destination 160 such as, but not limited to, the publishing portal 140, an editing system, a video server or a web interface (e.g. YouTube, etc.). One such application may reside on the encoder computing device 116. However, the application may also reside on any other portion of the media system 100 and may comprise a portion of the content storage management system 130, publishing portal 140 or storage device 120. At least a portion of the metadata may comprise information which describes the media and enhancements such as, but not limited to, closed captioning, visual cues, facial detection, and voice recognition data. In one embodiment, a user interface may be implemented at the encoder 110 to publish the content and send the metadata to a destination 160. Alternatively, the content and metadata may be sent to a destination via an automatic process such as, but not limited to, a script running at the encoder 110, content storage management system 130 or publishing portal 140. It is also contemplated that the rules engine may comprise a portion of the content storage management system 130 and/or publishing portal 140.

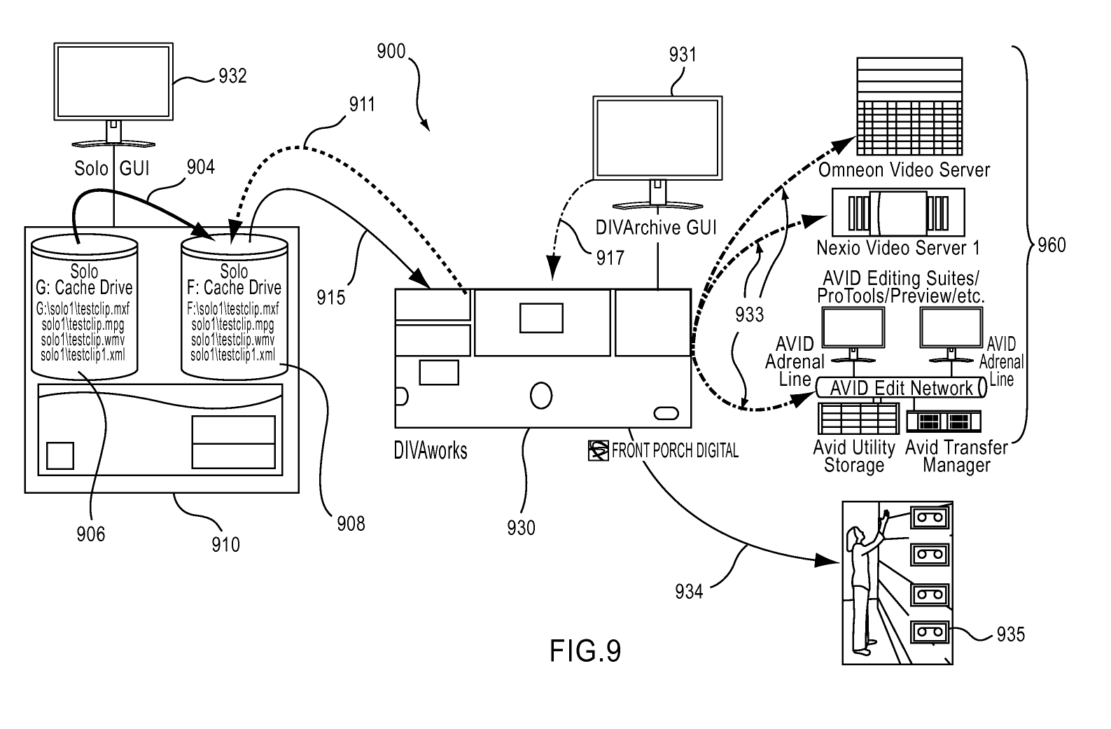

Turning now to FIG. 9, seen is another embodiment of a media system 900. One media system 900 comprises an encoder 910 and an encoder user interface 932. Upon content being successfully migrated at the encoder 910, the content is then moved 904 from the cache drive 906 to an internal nearline array 908 following post processing of the content for checksums, file quality, metadata generation, etc. under control of an encoder 910 migration application. The publishing portal 930 may periodically check 911 the nearline array for completed content. When the publishing portal 930 detects 915 completed content is present in the nearline array 908, the publishing portal 930 will initiate a plurality of operations comprising (i) initiating an archive operation including implementing a content lifecycle policy or a storage plan to create duplicate copies on multiple data tapes or multiple storage devices 122, potentially for disaster recovery purposes, (ii) comparing checksum values calculated by the encoder 910 during the encode process with those calculated by the publishing portal 930 on-the-fly during a transfer of the content from the nearline array 908 to the a storage facility 120 via the content storage management system 130, and (iii) upon determining the checksum values to be the same, deleting the original migrated content from the encoder nearline array 908 to make space for subsequent content migration. It is contemplated that the content storage management system 130 seen in FIG. 1 may have as a component, the publishing portal 930. Publishing portal 930 operations may be monitored and modified 917 via a publishing portal user interface 931. For example, modification of publishing portal operations may include re-prioritizing operations, modifying distribution schedules, adding or removing advertising material, cancelling active or pending jobs, etc. Upon receiving commands from (i) one or more control systems comprised of systems such as, but not limited to, a media asset management system 150 via a storage facility API 120 or (ii) the publishing portal user interface 931, the content storage management system 130 may restore 933 one or more portions of the migrated content to destinations 960 comprising consumption devices such as, but not limited to, editing systems, video servers, and/or online devices 160. All of these operations can be simple restores of migrated content in its native form or include advanced content storage management system 130 operations such as on-the-fly transcoding other media formats or timecode based partial restore operations where only selected portions of the migrated content is restored to the destination device. The content storage management system 130 may also store 934 data-tape copies of migrated content at an external location 935 (i.e. OFFLINE). The content storage management system 130 may track which content is stored at the external location 935, which provides a significant level of protection over catastrophic loss of valuable file-based assets in the storage facility 120. As mentioned previously this offline protection can either be achieved by taking duplicate data tapes and physically moving them offsite or allowing the content storage management system 130 to automatically replicate these assets digitally across any network connection to another remote content storage management system 130 and storage facility 120. It is contemplated that although this description of FIG. 9 refers to “content”, a similar FIG. 9 process may also relate to metadata created by the encoder 910.

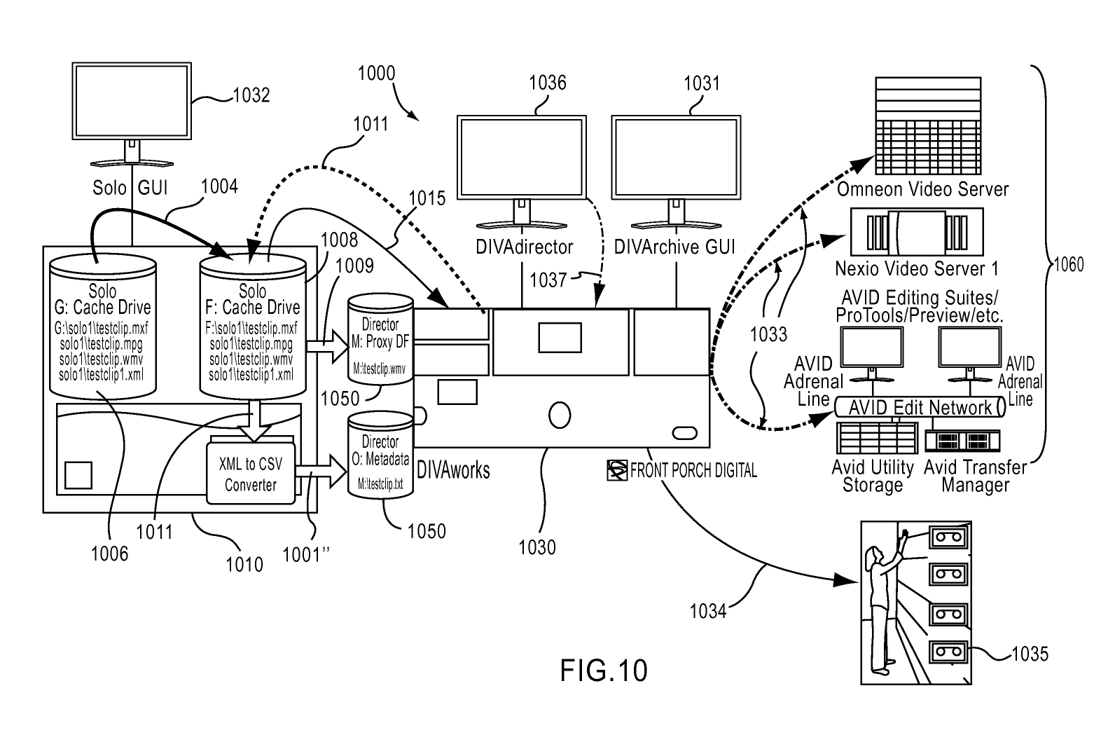

And turning now to FIG. 10, seen is yet another embodiment of a media system 1000. Successfully migrated content is moved 1004 to the internal nearline array 1004 following post processing of the content for checksums, metadata generation, file quality, etc. under control of the encoder migration application. The content storage management system may periodically check 1011 the nearline array 1004 completed content. When the content storage management system 130 detects 1015 completed content is present in the nearline array 1008, the content storage management system 130 will initiate a plurality of operations comprising (i) initiating an archive operation including implementing a content lifecycle policy or a storage plan to create duplicate copies on multiple data tapes or multiple storage devices 122, potentially for disaster recovery purposes, (ii) comparing checksum values calculated by the encoder 1010 during the encode process with those calculated by the content storage management system 130 on-the-fly during a transfer of the content from the nearline array 1008 to the a storage facility 120, and (iii) upon determining the checksum values to be the same, deleting the original migrated content from the encoder nearline array 1008 to make space for subsequent content migration.

In operations occurring parallel to the plurality of operations discussed above, proxy versions of the migrated content comprising low resolution but frame accurate content version, are created and passed 1009 to a Media Asset Management (MAM) system 1050 to enable desktop browsing, playback and shotlist creation for the migrated content from a user destination 1060 desktop using a web browser. Additionally, the encoder 1010 may parse 1001′ collected migration metadata and pass 1001″ this metadata on to a MAM System 1050 to allow for queries and metadata scrubbing from a destination 1060 desktop using a web browser.

A MAM system user interface 1050 may monitor 1037 the status of the publishing portal 1030 operations and may be used to trigger content restore operations to devices at the destinations 1060, allowing for review of (i) the low resolution proxy version copies of the migrated content and (ii) relevant detailed metadata prior to restoring the content. Upon receiving commands from (i) one or more control systems via a publishing portal API or (ii) the publishing portal user interface 1031 or (iii) the MAM system or (iv) the rules engine, the content storage management system may restore 1033 one or more portions of the migrated content to destinations 1060 comprising consumption devices such as, but not limited to, editing systems, video servers, and/or online devices via the publishing portal. All of these operations can be simple restores of migrated content in its native form or include advanced content storage management system operations such as on-the-fly transcoding to the required destination format or timecode based partial restore operations where only specific portions of the migrated content is restored to the destination device. The content storage management system may then store 1034 data-tape copies of migrated content at an external location 1035 (i.e. OFFLINE). The content storage management system may track which content is stored at the external location 1035, which provides a significant level of protection over catastrophic loss of valuable file-based assets in the storage facility 120. As mentioned previously this offline protection can either be achieved by taking duplicate data tapes and physically moving them offsite or allowing the content storage management system to automatically replicate these assets digitally across any network connection to a remote storage facility 120.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A media system comprising,
an encoder adapted to generate one or more digital files from media wherein, the media comprises at least one of a video source and an audio source;
a content storage management system and storage device, the content storage management system and storage device being adapted to store the one or more digital files;
at least one user interface adapted to enable a user to,
select at least a portion of the one or more digital files, and
create and modify metadata;
a publishing portal adapted to,
associate the metadata with the at least a portion of the one or more digital files,
enable the delivery of the at least a portion of the one or more digital files,
across one or more network types, and
to one or more device types,
implement a publishing schedule for the at least a portion of the one or more digital files; and
a destination adapted to receive the,
metadata, and
one or more digital files.

2. The media system of claim 1 wherein,
the media comprises at least one of,
a video tape, and
a linear file;
the storage device comprises,
at least one of,
a hard drive, and
a magnetic data tape,
the content storage management system comprises at least one of,
software and hardware to manage the storage devices, and
transcoding functionality, and
metadata generation functionality, and
interfaces to various devices, and
a rules engine, and
a mechanism adapted to adjust a bandwidth used by the encoder to transfer the content to the storage device; and
the publishing portal comprises a plurality of at least one of local and cloud-based publishing portals.

3. The media system of claim 1 wherein, the encoder comprises,
at least one input device comprising,
a robotic apparatus;
a VTR adapted to,
receive a videotape from the robotic apparatus, and
provide the media comprising the at least one of a video and an audio source,
an input device control interface; and
at least one output mechanism adapted to generate the one or more digital files, wherein, the one or more digital files,
comprise a plurality of video resolutions, and
are placed in independent directories on the storage device following a successful encode pass.

4. The media system of claim 1 wherein,
the publishing portal is further adapted to provide the content to a computing device; and
the content provided to the computing device comprises one of,
name mappings introduced at the publishing portal, and
at least one metadata field to identify the content name.

5. The media system of claim 1 wherein, the user interface comprises, an encoding user interface adapted to enable a storage naming configuration for the content.

6. The media system of claim 1 wherein, the publishing portal is further adapted to enable the delivery of the metadata to the destination.

7. The media system of claim 6 wherein, the metadata and the content are automatically delivered to the destination upon the encoder generating the one or more digital files.

8. A method of providing content to a device comprising,
placing the content on a storage device;
creating a content package by at least one of,
transcoding the content,
entering metadata into a file associated with the content,
establishing at least one of scheduling and distribution policies, and
associating advertising with the content; and
implementing one of,
a first operational mode comprising,
using a user interface adapted to operatively control one or more storage device features, and
pushing the content package to a publishing portal, and a second operational mode comprising,
accessing a publishing portal user interface,
viewing the content on the storage device,
selecting at least a portion of the content, and
pulling the content package to the publishing portal.

9. The method of claim 6 wherein,
viewing the content stored on the storage device comprises viewing all of the content stored on the storage device;
pushing the content package to the publishing portal comprises pushing one or more objects, each of the one or more objects comprising,
a metadata file, and
multiple encoded content files; and
pulling the content package to the publishing portal comprising pulling one or more objects, each of the one or more objects comprising,
a metadata file, and
multiple encoded content files.

10. The method of claim 6 further comprising, encoding the content prior to placing the content on the storage device; wherein,
the encoding the content comprises encoding the content in a plurality of formats; and
entering the metadata into a file comprises entering metadata adapted to be implemented by a plurality of formats.

11. The method of claim 6 wherein, the content package comprises at least one of,
a single object for each encoded file; and
a single object for a plurality of encoded files.

12. The method of claim 8 wherein,
encoding the content comprises saving the content to an encoding device local cache; and
placing the content on a storage device comprises,
moving the content from the encoding device to a folder on the storage device, and
deleting the content on the encoding device local cache.

13. The method of claim 10 wherein, saving the content to an encoding device local cache comprises saving the content with a unique filename for an encoding category.

14. The method of claim 11 wherein the encoding category comprises a folder containing content files for a unique identifier comprising at least one of,
an encoding format,
a video resolution, and
metadata.

15. A method of storing content files comprising,
monitoring a plurality of encoding folders for a digital media essence file to be created in each of the plurality of encoding folders;
transferring each of the digital media essence files to a storage device folder, each of the storage device folders comprising separate folders associated with an encoding folder the digital media essence file was created in;
implementing a storage plan for each of the storage device folders; and
accessing the digital media essence file via a user interface referencing,
an object name associated with the digital media essence file name, and
a category name associated with a storage device folder the digital media file is located in.

16. The method of claim 13 wherein, the transferring the digital media essence file to a storage device comprises transferring the digital media essence file to a storage device when a file size of the digital media essence ceases to increase for a given time period.

17. The method of claim 13 wherein, the storage plan comprises at least one of,
transcoding requirements;
number of copies; and
off-site replication.

18. The method of claim 13 further comprising,
creating a metadata file in a metadata encoding folder;
transferring the metadata file to a metadata storage device folder, the xml storage device folder being associated with the metadata encoding folder; and
accessing the metadata file via a user interface referencing,
an object name associated with the metadata file name, and
a category name associated with a file name of the metadata folder.

19. The method of claim 16 wherein, the xml file references,
at least one digital media essence file;
a file path of the at least one digital media essence file; and
at least one of,
an object name associated with the at least one digital media essence file, and
a category name associated with the at least one digital media essence file.

20. The method of claim 13 wherein,
each of the digital media essence files transferred to a storage device folder comprises a digital media object comprising a plurality of digital media essence files; and
accessing the digital media essence file via a user interface comprises accessing one of the plurality of digital media essence files.
